(19) United States
(12) Patent Application Publication
(10) Pub. No.: US 2019/0055340 A1
(43) Pub. Date: Feb. 21, 2019

(54) POLYMER AND PREPARATION AND USE THEREOF

(71) Applicant: Chuh-Yung Chen, Tainan City (TW)

(72) Inventors: Chuh-Yung Chen, Tainan City (TW); Hsin Yu, Tainan City (TW); Yuan-Hsiang Wu, Tainan City (TW); Ming-Yuan Shen, Tainan City (TW); Chen-Chien Wang, Tainan City (TW)

(21) Appl. No.: 15/679,791

(22) Filed: Aug. 17, 2017

(51) Int. Cl. C08G 18/28; C08G 18/48; C08G 18/42

(52) U.S. Cl. CPC C08G 18/2855; G01N 25/4866; C08G 18/4283; C08G 18/4804

(57) ABSTRACT

A polymer is represented by Formula (I):

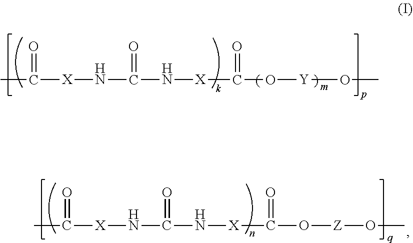

wherein X is a substituted or unsubstituted C₂-C₅ alkylene, alkenylene, or alkynylene group; Y is a substituted or unsubstituted divalent C₂-C₅ aliphatic hydrocarbyl group; Z is a divalent binding group; k is in a range from 0 to 3; m is in a range from 7 to 100; p is in a range from 0 to 30; n is in a range from 0 to 3; and q is in a range from 3 to 50.

The polymer is used as a nucleating agent for PET resin.

### FIELD

The disclosure relates to a polymer, and more particularly to a polymer which is useful as a nucleating agent for crystallization of polyethylene terephthalate. The disclosure also relates to preparation and use of the polymer.

### BACKGROUND

Polyethylene terephthalate (referred to as PET hereinafter) is commonly used as an optical material for forming a heat resistant film or a protective film of an optical product such as a liquid crystal display or a touch panel.

PET is of a formula represented by

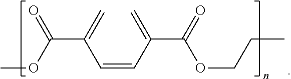

Since the binding group of —C—O— contained in the molecular chain of PET as shown in the formula may reduce symmetry of the molecular chain of PET, and the phenylene group contained in the molecular chain of PET may increase rigidity of the molecular chain of PET and hence hinder mobility of the molecular chain of PET, PET may have a relatively long crystal period, a relatively slow crystallization velocity, and a relatively low crystallinity. As a result, PET crystals have a relatively large crystal grain size and low transparence, and PET films have inferior mechanical strength. It is well known in the art to blend PET with a nucleating agent to solve the aforesaid problems.

A block copolymer including a polycarbonate block and a polyamide block which are suitable for interaction with an enthalpic effect in a polymer blend system is disclosed in Macromolecules, 1992, vol. 25, pp. 2977-2984.

### SUMMARY

A first object of the disclosure is to provide a polymer which is useful as a nucleating agent for crystallization of PET.

A second object of the disclosure is to provide a nucleating agent containing the polymer.

A third object of the disclosure is to provide a process for preparing the polymer.

A fourth object of the disclosure is to provide a highly transparent film containing the polymer.

A fifth object of the disclosure is to provide a compound which is useful as an intermediate for forming the polymer.

According to a first aspect of the disclosure, there is provided a polymer represented by Formula (I):

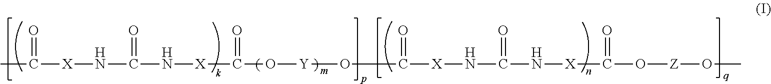

wherein

X is a substituted or unsubstituted C₂-C₅ alkylene, alkenylene, or alkynylene group;

Y is a substituted or unsubstituted divalent C₂-C₅ aliphatic hydrocarbyl group;

Z is a divalent binding group;

k is in a range from 0 to 3;

m is in a range from 7 to 100;

p is in a range from 0 to 30;

n is in a range from 0 to 3; and

q is in a range from 3 to 50.

According to a second aspect of the disclosure, there is provided a nucleating agent comprising the polymer represented by Formula (I).

According to a third aspect of the disclosure, there is provided a process for preparing the polymer represented by Formula (I), comprising:

a) subjecting a diester compound and a diol component to a transesterification reaction to obtain a transesterification product,

wherein
the diester compound is represented by

R⁵O—C(═O)—Z¹—C(═O)—OR⁶,
wherein
   each of R⁵ and R⁶ is independently a monovalent hydrocarbyl group, and
   Z¹ represents a divalent group of

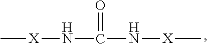

wherein X is a substituted or unsubstituted C₂-C₅ alkylene, alkenylene, or alkynylene group, and
the diol component includes a first diol compound represented by HO—Z—OH, wherein Z is a divalent binding group; and

b) subjecting the transesterification product to a polycondensation reaction.

According to a fourth aspect of the disclosure, there is provided a highly transparent film which is made from a composition including the polymer represented by Formula (I) and polyethylene terephthalate.

According to a fifth aspect of the disclosure, there is provided a diester compound which is useful as an intermediate for forming the polymer represented by Formula (I) and which is represented by R⁵O—C(═O)—Z¹—C(═O)—OR⁶,

wherein
each of R⁵ and R⁶ is independently a monovalent hydrocarbyl group, and
Z¹ represents a divalent group of

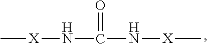

wherein X is a substituted or unsubstituted C₂-C₅ alkylene, alkenylene, or alkynylene group.

### BRIEF DESCRIPTION OF THE DRAWINGS

Other features and advantages of the disclosure will become apparent in the following detailed description of the embodiment (s) with reference to the accompanying drawings, of which:

FIG. 1 is an NMR spectrum diagram showing chemical shifts of hydrogen atoms at different positions of a polymer of Formula (VI) prepared in Example 1;

FIG. 2 is a diagram showing thermogravimetric analysis results for PET and optical films prepared in Application Examples 1 and 2;

FIG. 3 is a diagram showing differential scanning calorimetric results obtained in a second heating cycle of a differential scanning calorimetry for PET, a polymer prepared in Example 1, and the optical films prepared in Application Examples 1 and 2;

FIG. 4 is a diagram showing differential scanning calorimetric results obtained in a second cooling cycle of a differential scanning calorimetry for PET and the optical films prepared in Application Examples 1 and 2;

FIGS. 5-12 are a set of polarized optical microscopy (POM) images (1000× magnification) showing crystalline structures of the optical film prepared in Application Example 3 at different temperatures;

FIGS. 13-20 are another set of polarized optical microscopy (POM) images (1000× magnification) showing crystalline structures of the optical film prepared in Application Example 3 at different temperatures; and

FIG. 21 is an NMR spectrum diagram showing chemical shifts of hydrogen atoms at different positions of an intermediate of Formula (V) prepared in Preparation Example 1.

### DETAILED DESCRIPTION

A polymer according to the disclosure is represented by Formula (I):

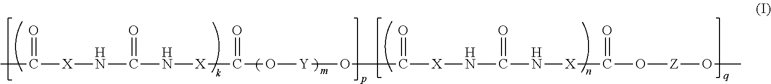

wherein

X is a substituted or unsubstituted C₂-C₅ alkylene, alkenylene, or alkynylene group;

Y is a substituted or unsubstituted divalent C₂-C₅ aliphatic hydrocarbyl group;

Z is a divalent binding group;

k is in a range from 0 to 3;

m is in a range from 7 to 100;

p is in a range from 0 to 30;

n is in a range from 0 to 3; and

q is in a range from 3 to 50.

In certain embodiments, X is a substituted or unsubstituted C₂-C₅ alkylene group. In the illustrative examples, X is pentylene.

In certain embodiments, Y is a substituted or unsubstituted C₂-C₅ alkylene group. In certain embodiments, Y is ethylene or isopropylene. In the illustrative examples, Y is ethylene.

In certain embodiments, Z is a C₂-C₁₀ alkylene group,

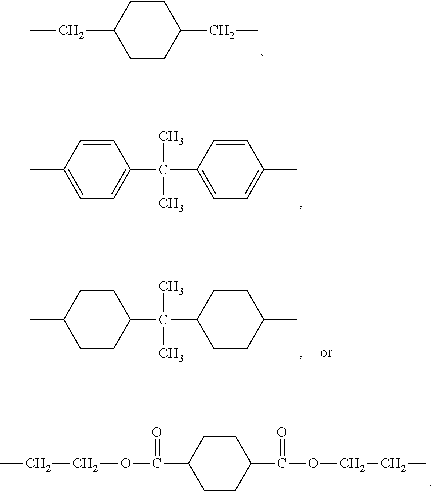

In the illustrative examples, Z is

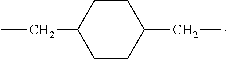

In certain embodiments, k is in a range from 1 to 3, m is in a range from 7 to 11, p is in a range from 1 to 15, n is in a range from 1 to 3, and q is in a range from 5 to 15.

In certain embodiments, an amount of a group of —(O—Y)ₘ—O— contained in the polymer represented by Formula (I) is in a range from 0 mol % to 12 mol % based on 100 mol % of the polymer. In certain embodiments, the amount of the group of —(O—Y)ₘ—O— contained in the polymer represented by Formula (I) is in a range from 9 mol % to 12 mol % based on 100 mol % of the polymer.

A nucleating agent according to the disclosure includes the polymer represented by Formula (I).

A process for preparing the polymer represented by Formula (I) according to the disclosure comprises:

a) subjecting a diester compound and a diol component to a transesterification reaction to obtain a transesterification product,

wherein
a diester compound is represented by

R⁵O—C(═O)—Z¹—C(═O)—OR⁶,
wherein
   each of R⁵ and R⁶ is independently a monovalent hydrocarbyl group, and
   Z¹ represents a divalent group of

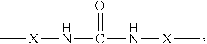

wherein X is a substituted or unsubstituted C₂-C₅ alkylene, alkenylene, or alkynylene group, and
the diol component includes a first diol compound represented by HO—Z—OH, wherein Z is a divalent binding group; and

b) subjecting the transesterification product to a polycondensation reaction.

In certain embodiments, each of R⁵ and R⁶ is independently a substituted or unsubstituted C₁-C₅ alkyl group.

In certain embodiments, the compound represented by R⁵O—C(═O)—Z¹—C(═O)—OR⁶ is obtained by subjecting a dihydrocarbyl ester compound and a lactam compound represented by Formula (II) to an esterification reaction,

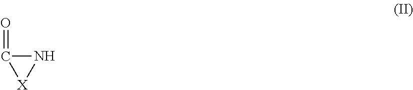

wherein X is a substituted or unsubstituted C₂-C₅ alkylene, alkenylene, or alkynylene group.

In certain embodiments, the dihydrocarbyl ester compound is a dihydrocarbyl carbonate compound. In certain embodiments, the dihydrocarbyl ester compound is a dialkyl ester compound. In certain embodiments, the dialkyl ester compound is represented by Formula (III):

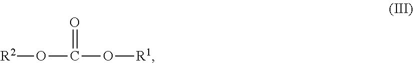

wherein each of R¹ and R² is independently a substituted or unsubstituted C₁-C₈ alkyl group.

In the illustrative examples, the dihydrocarbyl ester compound is dimethyl carbonate.

In certain embodiments, the esterification reaction is performed at a temperature ranging from 110° C. to 200° C. under a pressure ranging from 3 bars to 7 bars. In certain embodiments, the esterification reaction is performed at a temperature ranging from 140° C. to 160° C. under a pressure ranging from 5 bars to 6 bars.

In certain embodiments, the esterification reaction is performed for a period ranging from 16 hours to 18 hours.

In certain embodiments, X is a substituted or unsubstituted C₂-C₅ alkylene group. In the illustrative examples, X is pentylene.

In certain embodiments, a molar ratio of the dihydrocarbyl ester compound to the lactam compound is in a range from 0.5 to 1.5.

In certain embodiments, the diester compound represented by R⁵O—C(═O)—Z¹—C(═O)—OR⁶ is pressure-reduced to a pressure ranging from −0.3 bar to −1 bar at a temperature ranging from 150° C. to 200° C. prior to the transesterification reaction. In certain embodiments, the diester compound represented by R⁵O—C(═O)—Z¹-C(═O)—OR⁶ is pressure-reduced to a pressure ranging from −0.6 bar to −0.8 bar at a temperature ranging from 150° C. to 180° C. prior to the transesterification reaction.

In certain embodiments, the diol component used in step a) further includes a second diol compound represented by H-(0-Y)ₘ—OH, wherein Y is a substituted or unsubstituted divalent C₂-C₅ aliphatic hydrocarbyl group, and m is in a range from 7 to 100.

In certain embodiments, the transesterification reaction in step a) is performed at a temperature ranging from 110° C. to 200° C. under a pressure ranging from 0 bar to 5 bars. In certain embodiment, the transesterification reaction in step a) is performed at a temperature ranging from 160° C. to 170° C. under a pressure ranging from 2 bars to 3 bars.

In certain embodiments, the transesterification reaction in step a) is performed for a period ranging from 15 hours to 20 hours. In certain embodiments, the transesterification reaction in step a) is performed for a period ranging from 16 hours to 18 hours.

In certain embodiments, Y is a substituted or unsubstituted C₂-C₅ alkylene group. In certain embodiments, Y is ethylene or isopropylene. In the illustrative examples, Y is ethylene.

In certain embodiments, m is in a range from 7 to 100. In certain embodiments, m is in a range from 7 to 11.

In certain embodiments, examples of the second diol compound represented by H—(O—Y)ₘ—OH include, but are not limited to, polyethylene glycols having various molecular weights such as PEG-400, PEG-600, PEG-800, PEG-1000, PEG-2000, PEG-3000, PEG-4000, and the like; and polypropylene glycols having various molecular weights such as PPG-600, PPG-1000, PPG-2000, PPG-4000, and the like.

In certain embodiments, Z is a C₂-C₁₀ alkylene group,

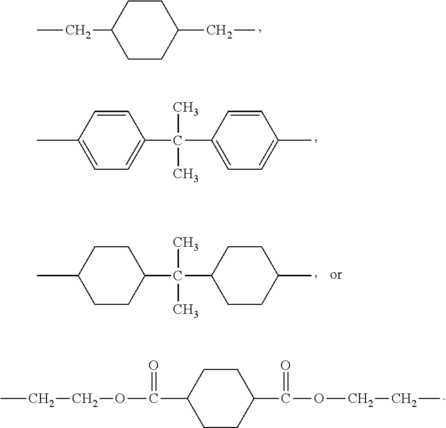

In the illustrative examples, Z is

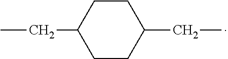

In certain embodiments, examples of the first diol compound represented by HO—Z—OH include, but are not limited to, 1,4-cyclohexanedimethanol, ethylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, and hydrogenated bisphenol A.

In certain embodiments, a molar ratio of the diester compound to the diol component ranges from 0.9 to 1.1.

In certain embodiments, when the diol component includes both the first diol compound and the second diol compound, the first diol compound is in an amount ranging from 70 mol % to 95 mol % based on 100 mol % of a combination of the first diol compound and the second diol compound. In certain embodiments, when the diol component includes both the first diol compound and the second diol compound, the first diol compound is in an amount ranging from 85 mol % to 95 mol % based on 100 mol % of a combination of the first diol compound and the second diol compound. In the illustrative examples, the first diol compound is in an amount of 90 mol % based on 100 mol % of a combination of the first diol compound and the second diol compound.

In certain embodiments, the polycondensation reaction in step b) is performed at a temperature ranging from 160° C. to 210° C. under a pressure ranging from 0.5 Torr to 2.5 Torr. In certain embodiments, the polycondensation reaction in step b) is performed at a temperature ranging from 170° C. to 190° C. under a pressure ranging from 1 Torr to 2 Torr.

In certain embodiments, the polycondensation reaction in step b) is performed for a period ranging from 5 hours to 6 hours.

In certain embodiments, the process for preparing the polymer represented by Formula (I) according to the disclosure further includes a purification step in which a product containing the polymer represented by Formula (I) is dissolved in a solvent to forma solution, followed by extraction of the polymer from the solution using an extraction medium to obtain the polymer in a purified form. The solvent suitable for forming the solution includes dimethylformamide, dimethylacetamide, and the like. The extraction medium suitable for the extraction includes diethyl ether and the like.

A highly transparent film according to the disclosure is made from a composition including the polymer represented by Formula (I) and polyethylene terephthalate.

In certain embodiments, the highly transparent film is made by melt blending the composition.

A diester compound according to the disclosure is useful as an intermediate for forming the polymer represented by Formula (I) and is represented by

R⁵O—C(═O)—Z¹—C(═O)—OR⁶,

wherein
each of R⁵ and R⁶ is independently a monovalent hydrocarbyl group, and
Z¹ represents a divalent group of

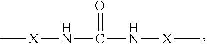

wherein X is a substituted or unsubstituted C₂-C₅ alkylene, alkenylene, or alkynylene group.

In certain embodiments, each of R⁵ and R⁶ is independently a substituted or unsubstituted C₁-C₈ alkyl group. In certain embodiments, each of R⁵ and R⁶ is independently a substituted or unsubstituted C₁-C₅ alkyl group.

Examples of the disclosure will be described hereinafter. It is to be understood that these examples are exemplary and explanatory and should not be construed as a limitation to the disclosure.

### Preparation Example 1

### Preparation of an Intermediate of Formula (V):

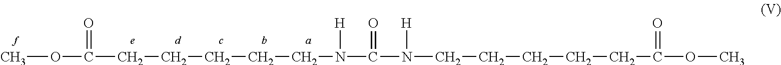

A reaction tank of an autoclave was sealed, followed by vacuum pumping and purging with nitrogen three times to remove water and air therefrom.

Dimethyl carbonate (495 g, 5.5 mol, manufactured by Chi Mei Corporation) and caprolactam (565.8 g, 5 mol, manufactured by Alfa Aesar) were added into the reaction tank of the autoclave during purging with nitrogen two or three times to provide a nitrogen atmosphere in the reaction tank. The pressure in the reaction tank was adjusted to 5.5 bars using a pressure regulating valve. The temperature in the reaction tank was raised at a rate of 5° C./30 mins to 160° C., followed by a reaction at a rotation speed of 80 rpm for 17 hours. A top portion of the autoclave was opened and heated after 1 hour of the reaction to remove methanol. The pressure in the reaction tank was released after 2 hours of the reaction. The temperature at the top portion of the autoclave and the amount of methanol were monitored every 30 minutes, and the pressure in the reaction tank was maintained at 5.5 bars. When the temperature at the top portion of the autoclave began to drop, the pressure in the reaction tank was released continuously to continuously remove methanol so as to permit the reaction to proceed continuously. A coarse product containing an intermediate of Formula (V) was obtained after the pressure in the reaction tank was released to 1 atm and methanol was not further produced.

The pressure in the reaction tank was reduced to −0.7 bar and the temperature in the reaction tank was raised to 170° C. to remove residual methanol to obtain the intermediate of Formula (V).

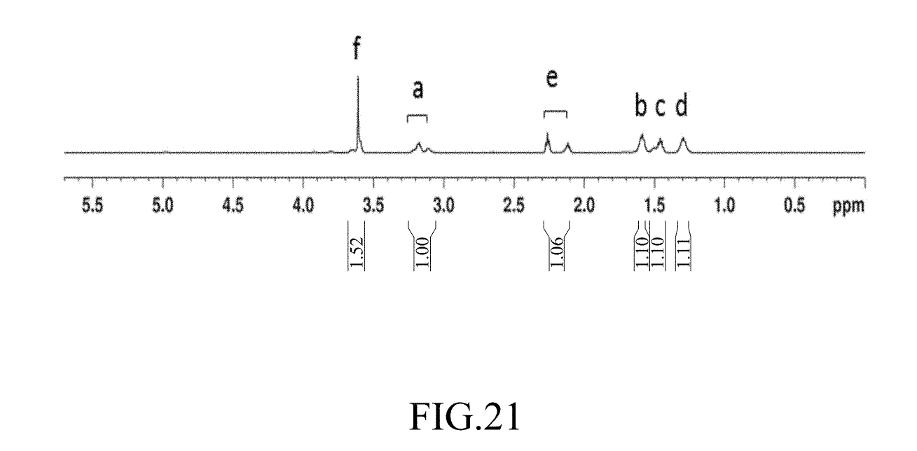

An NMR spectrum of the intermediate of Formula (V) is shown in FIG. 21. Hydrogen atoms at various positions of Formula (V) are marked as a, b, c, d, e, and f, and chemical shifts of these hydrogen atoms at positions a, b, c, d, e, and f are 3.1-3.2, 1.6, 1.45, 1.3, 2.1-2.3, and 3.6, respectively.

### Example 1

### Preparation of a Polymer of Formula (VI)

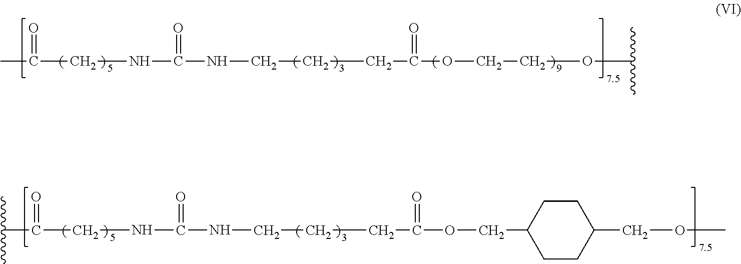

A reaction tank of an autoclave was sealed, followed by vacuum pumping and purging with nitrogen three times to remove water and air therefrom.

The intermediate of Formula (V) prepared in Preparation Example 1 (432 g, 1.5 mol), 1,4-cyclohexanedimethanol (189 g, 1.35 mol), and polyethylene glycol (PEG-400, 60 g, 0.15 mol, manufactured by Fluka) were added into the reaction tank of the autoclave during purging with nitrogen two or three times to provide a nitrogen atmosphere in the reaction tank. The pressure in the reaction tank was adjusted to 2.5 bars using a pressure regulating valve. The temperature in the reaction tank was raised at a rate of 5° C./30 mins to a transesterification temperature of 170° C., followed by a transesterification reaction at a rotation speed of 80 rpm for 17 hours. A top portion of the autoclave was opened and heated after 1 hour of the transesterification reaction to remove methanol. The pressure in the reaction tank was released after hours of the transesterification reaction. The temperature at the top portion of the autoclave and the amount of methanol were monitored every 30 minutes, and the pressure in the reaction tank was maintained at 2.5 bars. When the temperature at the top portion of the autoclave began to drop, the pressure in the reaction tank was released continuously to continuously remove methanol so as to permit the transesterification reaction to proceed continuously. A transesterification product was obtained after the pressure in the reaction tank was released to 1 atm and methanol was not further produced.

The reaction tank containing the transesterification product was heated to a polycondensation temperature of 180° C. The reaction tank was vacuumed in three stages using a vacuum pump so as to avoid removing the transesterification product from the reaction tank. At the first stage, a ball valve was opened slightly for 2 hours. At the second stage, the ball valve was set in a one-third open state to reduce the pressure in the reaction tank to 15 Torr. At the third stage, the ball valve was set in a two-thirds open state or a fully open state to reduce the pressure in the reaction tank to 1-2 Torr, followed by a polycondensation reaction. A coarse product containing a polymer of Formula (VI) was obtained when a torque value was raised to 98 watts (after 5-6 hours of the polycondensation reaction).

The coarse product containing the polymer of Formula (VI) was dissolved in dimethylformamide to prepare a solution containing 20 wt % of the polymer of Formula (VI) (a yellowish solution). The solution was added slowly dropwise to diethyl ether in a 1/5 volume ratio, followed by filtration, solvent removal, and baking in an oven at 60° C. to obtain the polymer of Formula (VI) as a purified product.

### Application Examples 1-3

### Preparation of Optical Films

A PET resin (SHINPET-5015W) was baked in an oven at 160° C. for 4 hours, and the polymer of Formula (VI) prepared in Example 1 was baked in an oven at 100° C. for 10 hours.

The baked PET resin and the baked polymer of Formula (VI) in the amounts shown in Table 1 were blended, molten, and extruded using an extruder manufactured by Brabender (270° C., 300 seconds, 90 rmp) to obtain optical films.

TABLE 1

| | Amount of the polymer of |
|---|---|
| Application | Formula (VI) |
| Examples | (wt %*) |
| 1 | 5 |
| 2 | 3 |
| 3 | 1 |

*based on a total amount of the PET resin and the polymer of Formula (VI)

### Nuclear Magnetic Resonance Spectroscopy Analysis:

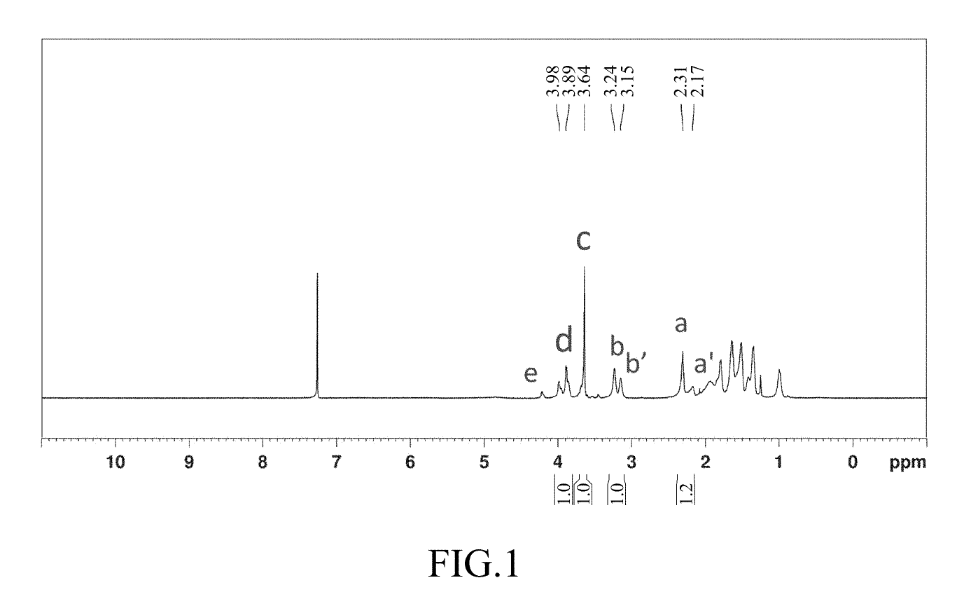

The polymer of Formula (VI) prepared in Example 1 was analyzed by nuclear magnetic resonance (NMR) spectroscopy. The NMR spectrum of the polymer of Formula (VI) is shown in FIG. 1. Hydrogen atoms at various positions of Formula (VI) are marked as a, b, c, d, e, a′, and b′ in Formula (VII) below, and chemical shifts of these hydrogen atoms at positions a, b, c, d, e, a′, and b′ are summarized in Table 2 below.

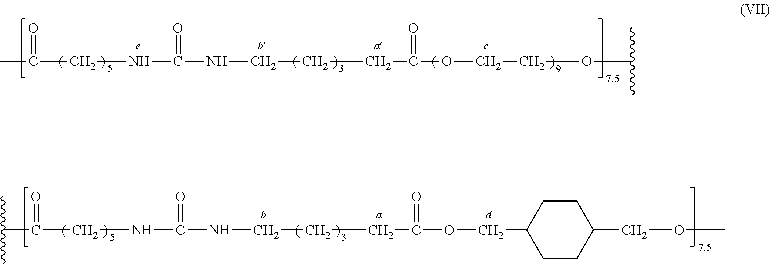

TABLE 2

| Positions | Chemical shifts(ppm) |
|---|---|
| a | 2.31 |
| a′ | 2.17 |
| b | 3.24 |
| b′ | 3.15 |
| c | 3.64 |
| d | 3.89 \grave{ } 3.98 |
| e | 4.7 |

As shown in FIG. 1 and Table 2, since 1,4-cyclohexanedimethanol has cis- and trans-isomeric forms, the hydrogen atoms at position d has two peaks. In addition, the amount of PEG was calculated according to Formula (A) below to be about 11 mol % based on 100 mol % of the polymer of Formula (VI).

Amount of PEG (mol %)=((A₁/n₁)/(A₂/n₂))×100% (A),

in which

A₁ represents a characteristic peak value of the hydrogen atoms at position c (i.e., the hydrogen atom in the PEG residual) and is 1,

A₂ represents a total of a characteristic peak value of the hydrogen atom at position b and a characteristic peak value of the hydrogen atom at position b′ (i.e., the hydrogen atoms at —CH₂— of —CH₂—NH—C(═O)—NH—CH₂—) and is 1,

n₁ represents the number of the hydrogen atoms in PEG and is 36, and

n₂ represents the number of the hydrogen atoms at —CH₂— of —CH₂—NH—C(═O)—NH—CH₂— and is 4.

### Thermogravimetric Analysis (TGA):

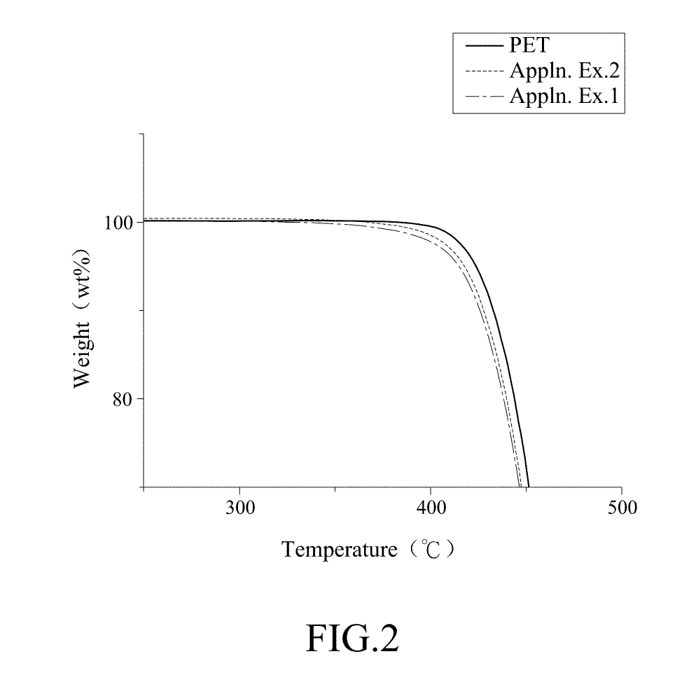

The PET resin and the optical films prepared in Application Examples 1 and 2 were respectively analyzed using a thermogravimetric analyzer, and the results thereof are shown in FIG. 2. A 5% weight loss heating temperature (T_{d5}, i.e., thermal degradation temperature) of each of the PET resin and the optical films prepared in Application Examples 1 and 2 is shown in Table 3 below.

TABLE 3

| | Amount of polymer of | |
|---|---|---|
| | Formula (VI) | T_{d5} |
| | (wt %) | (° C.) |
| Appln. Ex. 1 | 5 | 414 |
| Appln. Ex. 2 | 3 | 418.02 |
| PET resin | 0 | 423.5 |

As shown in FIG. 2 and Table 3, the thermal degradation temperature of the optical film is reduced when the amount of the polymer of Formula (IV) in the optical film is increased.

### Differential Scanning Calorimetry (DSC) Analysis:

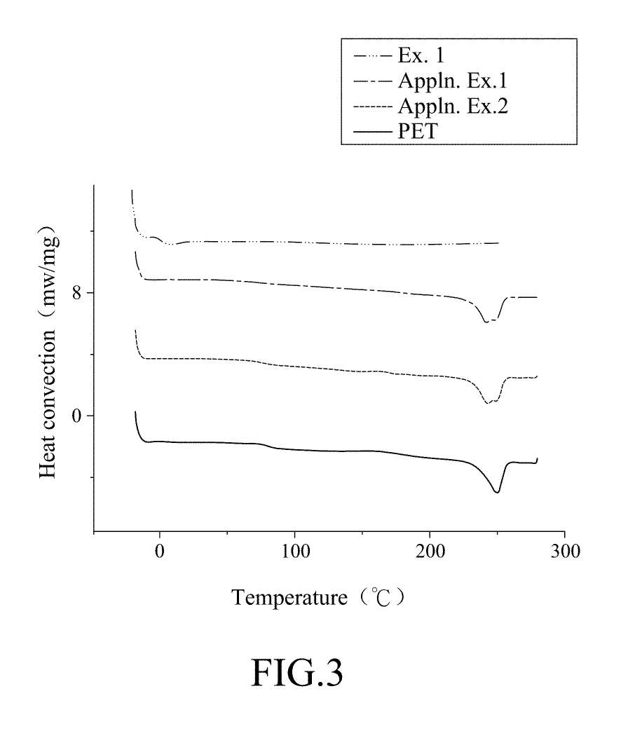

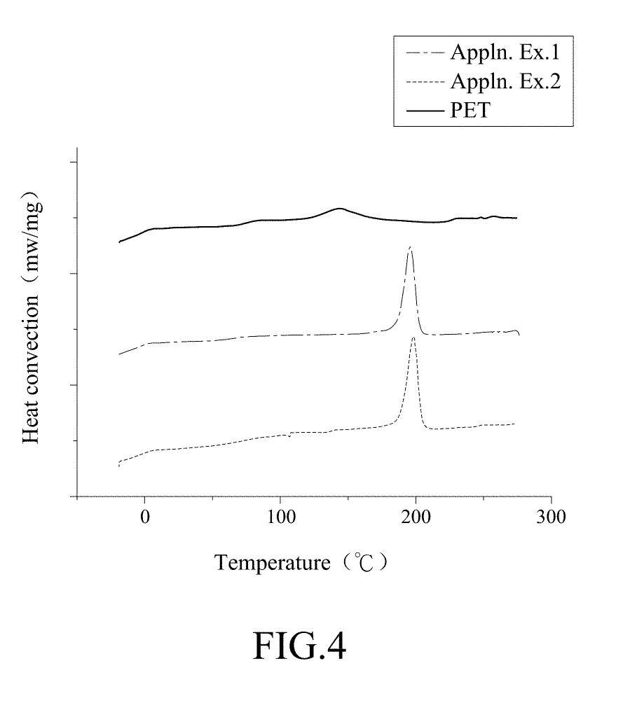

The PET resin, the polymer of Formula (VI) prepared in Example 1, and the optical films prepared in Application Examples 1 and 2 were respectively analyzed using a differential scanning calorimeter (Dupont TA2910 commercially available from Dupont) at a heating rate of 10° C./min and a cooling rate of 10° C./min. A second heating cycle of a differential scanning calorimetry for each of the PET, the polymer of Formula (VI) prepared in Example 1, and the optical films prepared in Application Examples 1 and 2 is shown in FIG. 3, and a second cooling cycle of a differential scanning calorimetry for each of the PET resin and the optical films prepared in Application Examples 1 and 2 is shown in FIG. 4.

As shown in FIG. 3, the peak at 0.9° C. (glass transition temperature) in the curve for the polymer of Formula (VI) prepared in Example 1 does not appear in the curves for the optical films prepared in Applications 1 and 2 by blending the polymer of Formula (VI) and the PET resin. This demonstrates that there is no incompatibility or phase separation between the polymer of Formula (VI) and the PET resin in the optical films prepared in Application Examples 1 and 2.

It can be found from FIG. 4 that the crystallization temperatures in Application Examples 1 and 2 are 202.5° C. and 204° C., respectively, both of which are higher than the crystallization temperature (about 151° C.) of the PET resin. The crystallization temperature in Application Example 1, in which the amount of the polymer of Formula (VI) is 5 wt %, is relatively low as compared to that in Application Example 2, in which the amount of the polymer of Formula (VI) is 3 wt %, less than that (5 wt %) in Application Example 1.

In addition, it can also be found from FIG. 4 that the crystallization peak obtained in each of Application Examples 1 and 2 is relatively narrow and high as compared to that obtained for the PET resin. This demonstrates that the crystallinity of the PET resin may be enhanced by blending the polymer of Formula (VI) prepared in Example 1 with the PET resin. In other words, the polymer of Formula (VI) prepared in Example 1 may be used as a nucleating agent for enhancing the crystallization of the PET resin.

Moreover, at the same cooling rate, crystallization began at 202.5° C. in Application Example 1 and at 204° C. in Application Example 2. However, crystallization began at a relatively low temperature of 151° C. for the PET resin. This demonstrates that the crystallization velocity of the PET resin may be enhanced by blending the polymer of Formula (VI) prepared in Example 1 with the PET resin. In other words, the polymer of Formula (VI) prepared in Example 1 may be used as a nucleating agent for enhancing the crystallization of the PET resin.

### Polarized Optical Microscope (POM) Analysis:

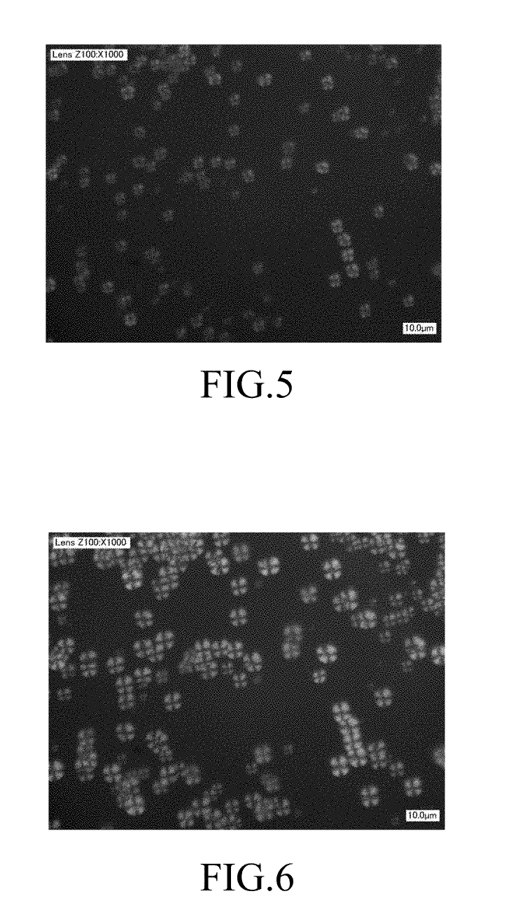

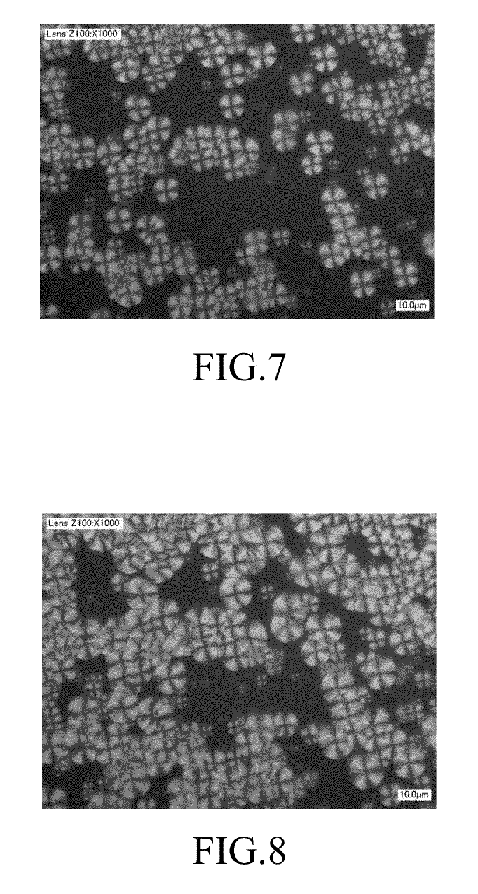

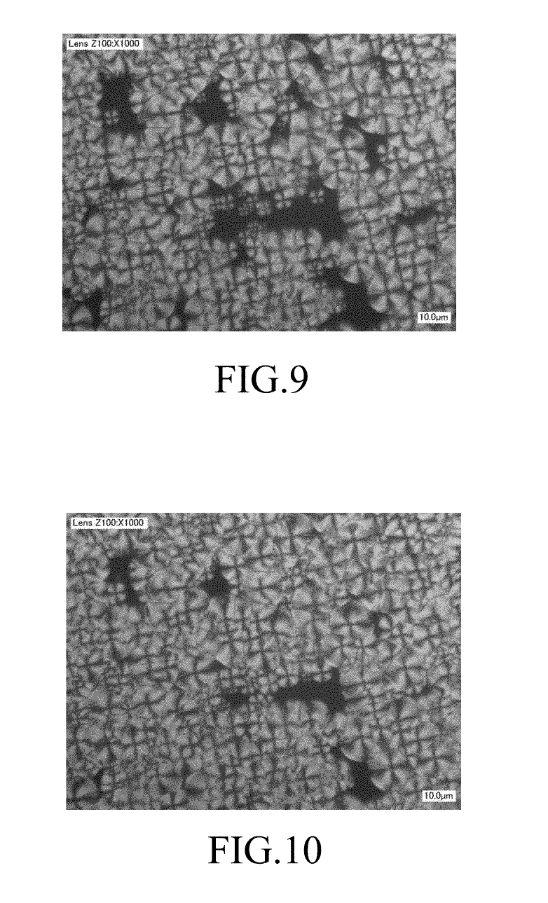

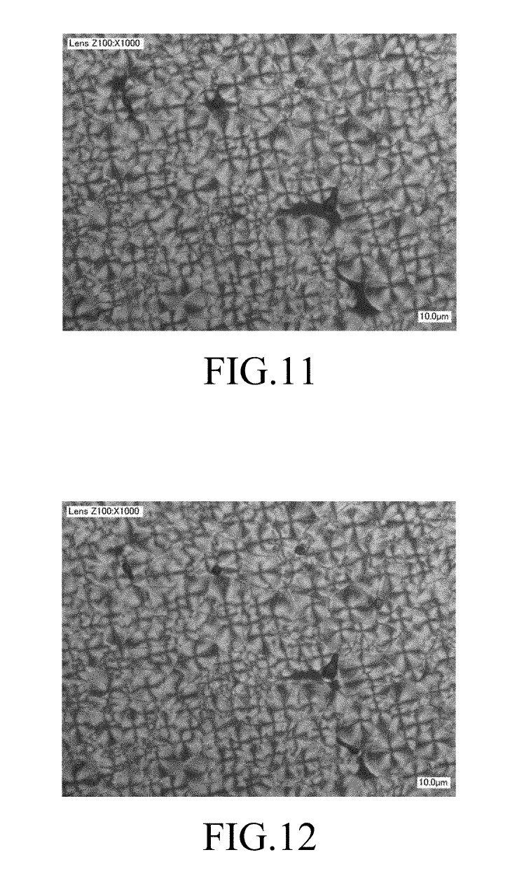

The optical film prepared in Application Example was placed on a microscopic slide, followed by placement of the microscopic slide together with the optical film on a heating stage. The optical film was heated. After the optical film was molten at 270° C., the optical film was covered with another slide and the heating was ceased. The crystal variation of the optical film was observed using a polarized optical microscope (Keyence VHX-J100) while the temperature of the optical film was reduced gradually. The optical film at 191.0° C., 185.0° C., 179.0° C., 173.0° C., 166.9° C., 161.0° C., 155.0° C., and 149.0° C. was photographed at 1000× magnification to obtain the images shown respectively in FIGS. 5-12.

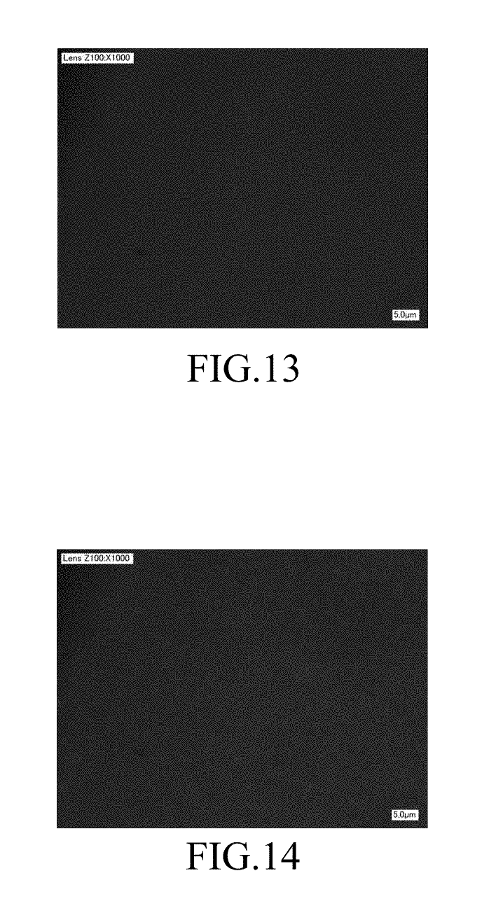

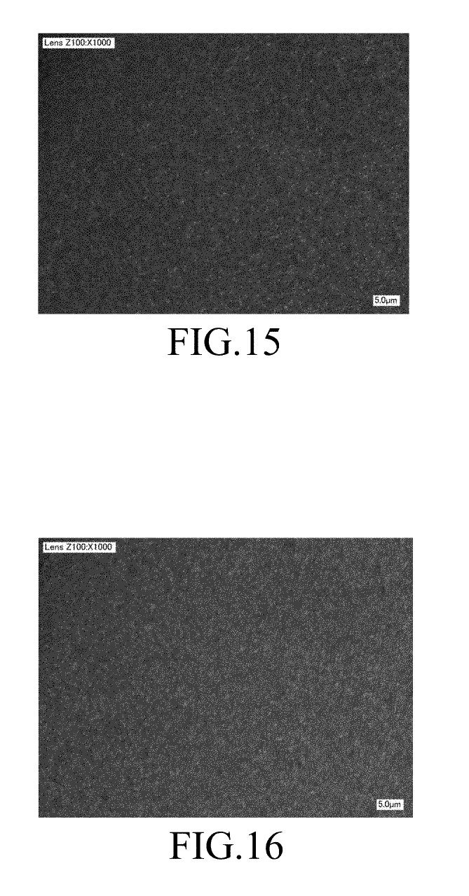

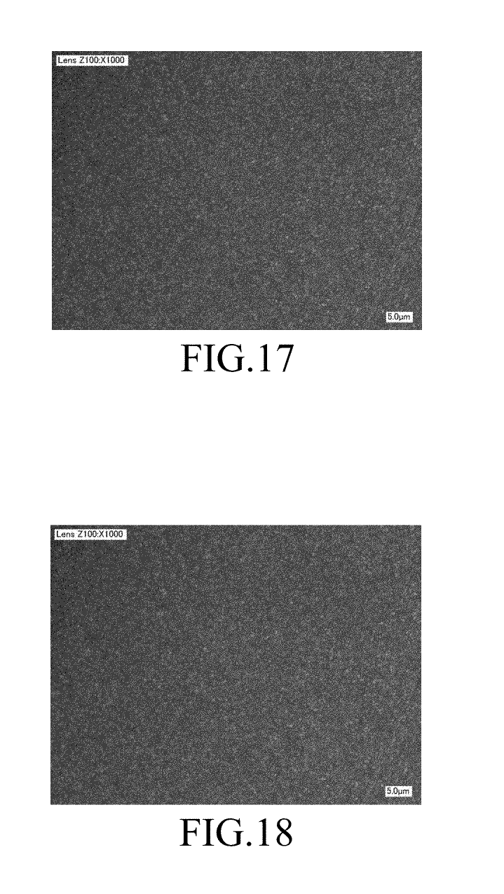

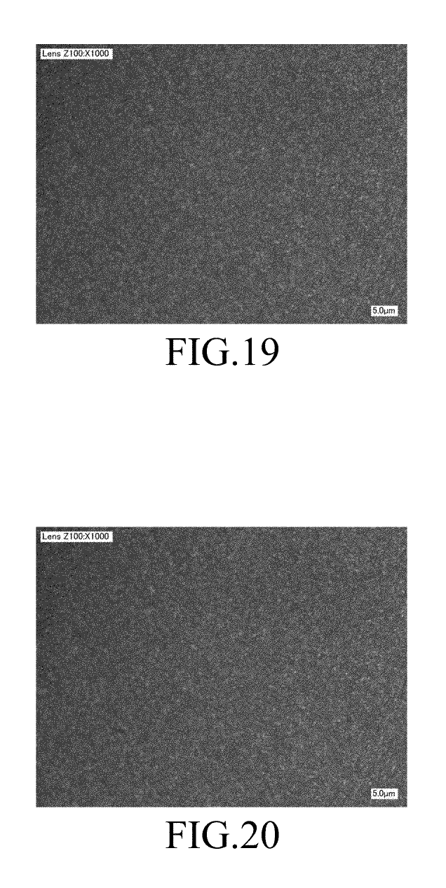

The temperatures for taking the images shown in FIGS. 5-12 are summarized in Table 4. In addition, The optical filmat 213.0° C., 210.0° C., 207.0° C., 204.0° C., 201.0° C., 198.0° C., 195.0° C., and 192.0° C. was photographed at 1000× magnification according to the aforesaid process to obtain the images shown respectively in FIGS. 13-20. The temperatures for taking the images shown in FIGS. 13-20 are summarized in Table 5.

TABLE 4

| | Temperatures |
|---|---|
| FIGS. | (° C.) |
| 5 | 191.0 |
| 6 | 185.0 |
| 7 | 179.0 |
| 8 | 173.0 |
| 9 | 166.9 |
| 10 | 161.0 |
| 11 | 155.0 |
| 12 | 149.0 |

TABLE 5

| | Temperatures |
|---|---|
| FIGS. | (° C.) |
| 13 | 213.0 |
| 14 | 210.0 |
| 15 | 207.0 |
| 16 | 204.0 |
| 17 | 201.0 |
| 18 | 198.0 |
| 19 | 195.0 |
| 20 | 192.0 |

As shown in FIGS. 5 to 12, crystals began to appear at 191.0° C., and the amount thereof increased gradually when the temperature was further reduced. This demonstrates that the polymer of Formula (VI) prepared in Example 1 may be used as a nucleating agent for enhancing the crystallization of the PET resin. In addition, it may be found from FIGS. 5-20 that the crystal grain size obtained in Application Example 3 is significantly smaller than that for the PET resin (15 μm to 30 μm). This demonstrates that the polymer of Formula (VI) prepared in Example 1 may be used as a nucleating agent for enhancing the crystallization of the PET resin and that the crystal grain size may be reduced accordingly so as to enhance transparence of the optical film.

In the description above, for the purposes of explanation, numerous specific details have been set forth in order to provide a thorough understanding of the embodiment(s). It will be apparent, however, to one skilled in the art, that one or more other embodiments may practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A polymer represented by Formula (I): 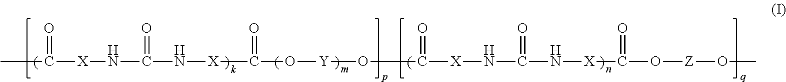
wherein
X is a substituted or unsubstituted C₂-C₅ alkylene, alkenylene, or alkynylene group;
Y is a substituted or unsubstituted divalent C₂-C₅ aliphatic hydrocarbyl group;
Z is a divalent binding group;
k is in a range from 0 to 3;
m is in a range from 7 to 100;
p is in a range from 0 to 30;
n is in a range from 0 to 3; and
q is in a range from 3 to 50.

2. The polymer according to claim 1, wherein X is a substituted or unsubstituted C₂-C₅ alkylene group.

3. The polymer according to claim 1, wherein Y is a substituted or unsubstituted C₂-C₅ alkylene group.

4. The polymer according to claim 1, wherein Z is a C₂-C₁₀ alkylene group,

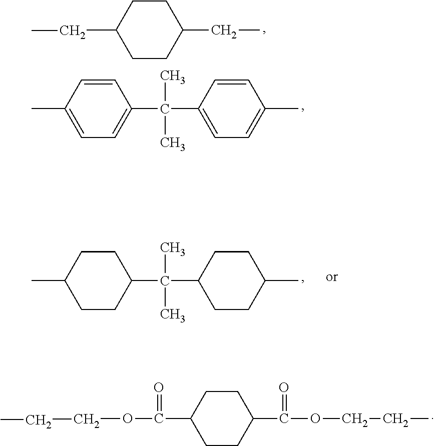

5. The polymer according to claim 1, wherein an amount of a group of —(O—Y)ₘ—O— contained in the polymer is in a range from 0 mol % to 12 mol % based on 100 mol % of the polymer.

6. A nucleating agent comprising the polymer according to claim 1.

7. A process for preparing the polymer according to claim 1, comprising:
a) subjecting a diester compound and a diol component to a transesterification reaction to obtain a transesterification product,
wherein
the diester compound is represented by
R⁵O—C(═O)—Z¹—C(═O)—OR⁶,
wherein
each of R⁵ and R⁶ is independently a monovalent hydrocarbyl group, and
Z¹ represents a divalent group of 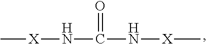
wherein X is a substituted or unsubstituted C₂-C₅ alkylene, alkenylene, or alkynylene group, and
the diol component includes a first diol compound represented by HO—Z—OH, wherein Z is a divalent binding group; and
b) subjecting the transesterification product to a polycondensation reaction.

8. The process according to claim 7, wherein each of R⁵ and R⁶ is independently a substituted or unsubstituted C₁-C₅ alkyl group.

9. The process according to claim 7, wherein the compound represented by R⁵O—C(═O)—Z¹—C(═O)—OR⁶ is obtained by subjecting a dihydrocarbyl ester compound and a lactam compound represented by Formula (II) to an esterification reaction, 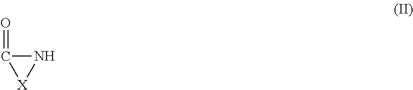
wherein X is a substituted or unsubstituted C₂-C₅ alkylene, alkenylene, or alkynylene group.

10. The process according to claim 9, wherein the dihydrocarbyl ester compound is a dihydrocarbyl carbonate compound.

11. The process according to claim 7, wherein the diol component further includes a second diol compound represented by H—(O—Y)ₘ—OH, wherein Y is a substituted or unsubstituted divalent C₂-C₅ aliphatic hydrocarbyl group, and m is in a range from 7 to 100.

12. The process according to claim 7, wherein the transesterification reaction is performed at a temperature ranging from 110° C. to 200° C. under a pressure ranging from 0 bar to 5 bars.

13. The process according to claim 7, wherein the polycondensation reaction is performed at a temperature ranging from 160° C. to 210° C. under a pressure ranging from 0.5 Torr to 2.5 Torr.

14. The process according to claim 9, wherein the esterification reaction is performed at a temperature ranging from 110° C. to 200° C. under a pressure ranging from 3 bars to 7 bars.

15. The process according to claim 7, wherein Z is a C₂-C₁₀ alkylene group,

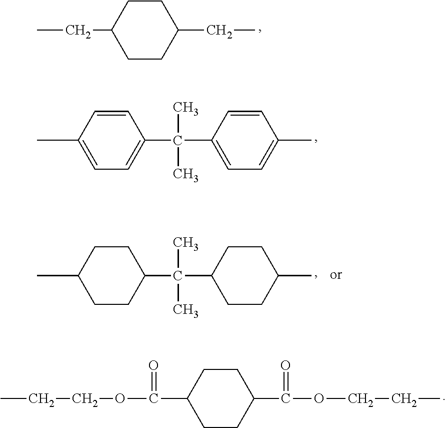

16. The process according to claim 9, wherein X is a substituted or unsubstituted C₂-C₅ alkylene group.

17. The process according to claim 11, wherein Y is a substituted or unsubstituted C₂-C₅ alkylene group.

18. A highly transparent film made from a composition including the polymer according to claim 1 and polyethylene terephthalate.

19. A diester compound represented by
R⁵O—C(═O)—Z¹—C(═O)—OR⁶,
wherein
each of R⁵ and R⁶ is independently a monovalent hydrocarbyl group, and
Z¹ represents a divalent group of 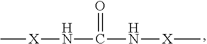
wherein X is a substituted or unsubstituted C₂-C₅ alkylene, alkenylene, or alkynylene group.

20. The compound according to claim 19, wherein each of R⁵ and R⁶ is independently a substituted or unsubstituted C₁-C₅ alkyl group.
